(19) United States
(12) Patent Application Publication
(10) Pub. No.: US 2024/0400737 A1
(43) Pub. Date: Dec. 5, 2024

(54) COPOLYMER, COMPOSITION, AND ARTICLE

(71) Applicant: AGC Inc., Tokyo (JP)

(72) Inventors: Taihei TANIGUCHI, Tokyo (JP); Hajime EGUCHI, Tokyo (JP); Ryohei KOGUCHI, Tokyo (JP)

(73) Assignee: AGC Inc., Tokyo (JP)

(21) Appl. No.: 18/805,628

(22) Filed: Aug. 15, 2024

Related U.S. Application Data
(63) Continuation of application No. PCT/JP2023/007821, filed on Mar. 2, 2023.

(30) Foreign Application Priority Data
Mar. 15, 2022 (JP) 2022-040671

(51) Int. Cl. C08F 220/28; C08F 293/00

(52) U.S. Cl. CPC C08F 220/28; C08F 293/00

(57) ABSTRACT

A copolymer having a unit (A) having a reactive silyl group, a unit (B) having a group represented by formula (1) shown below, and a unit (C) represented by formula (2) shown below. In the formulas, n1 represents 2 or 3, and n2 represents an integer of 0 to 300, n3 represents 2 or 3, n4 represents an integer of 0 to 300, R⁶ represents an alkyl group, and the ratio represented by (n4+1)/(number of carbon atoms in R⁶) is at least 0.5 but less than 9.

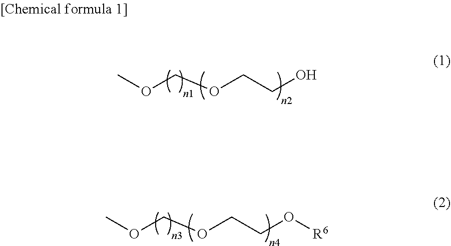

### BACKGROUND OF THE INVENTION

### Field of the Invention

The present invention relates to a copolymer, a composition, and an article. This application is a continuation application of International Application No. PCT/JP2023/007821, filed on Mar. 2, 2023, which claims priority to Japanese Patent Application No. 2022-040671, filed Mar. 15, 2022, the entire contents of which are incorporated herein by reference.

### Description of Related Art

The surfaces of medical devices and bioanalytical equipment and the like come into contact with biological components such as blood, cells and proteins during use, and therefore need to be resistant to the adsorption of such biological components (also described as having “non-adsorptivity”). Accordingly, methods have been proposed in which a compound having a biocompatible group is used to coat the surface of a substrate, thereby inhibiting adsorption of biological components.

International Patent Publication, No. 2019/198374 discloses a medical device provided with a surface layer on at least a portion of the surface of the device substrate, the surface layer being formed from the cured product of a compound having a biocompatible group and an alkoxysilyl group. Examples of the compound having a biocompatible group and an alkoxysilyl group include copolymers having a unit based on a (meth)acrylate having a polyoxyethylene structure and a unit based on a (meth)acrylate having an alkoxysilyl group.

### SUMMARY OF THE INVENTION

However, the non-adsorptivity of the surface layer disclosed in International Patent Publication, No. 2019/198374 is still not adequate.

The present invention provides a copolymer and a composition capable of forming a surface layer having excellent non-adsorptivity, as well as an article having excellent non-adsorptivity.

### Solution to Problem

The present invention includes the following aspects.

[1] A copolymer including a unit (A) having a reactive silyl group, a unit (B) having a group represented by formula (1) shown below, and a unit (C) represented by formula (2) shown below:

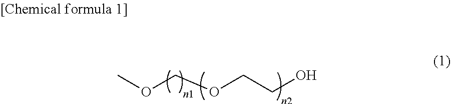

wherein n1 represents 2 or 3, and n2 represents an integer of 0 to 300,

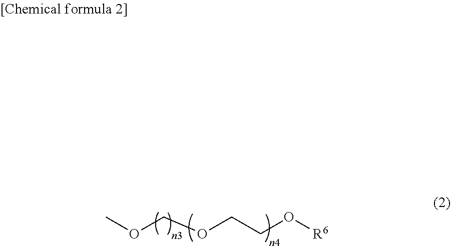

wherein R⁶ represents an alkyl group, n3 represents 2 or 3, n4 represents an integer of 0 to 300, and a ratio represented by (n4+1)/(number of carbon atoms in R⁶) is at least 0.5 but less than 9.
[2] The copolymer according to [1], wherein the proportion of the unit (B) relative to the combined total of the unit (B) and the unit (C) is within a range from 0.1 to 90% by mass.
[3] The copolymer according to [1] or [2], wherein n2 in the formula (1) is 0.
[4] The copolymer according to any one of [1] to [3], wherein in formula (2), either n3 is 3, n4 is 0 and R⁶ represents a methyl group, or n3 is 2, n4 is an integer of 0 to 7, and R⁶ represents a methyl group or an ethyl group.
[5] The copolymer according to any one of [1] to [4], wherein the unit (B) is represented by formula (B-1) shown below:

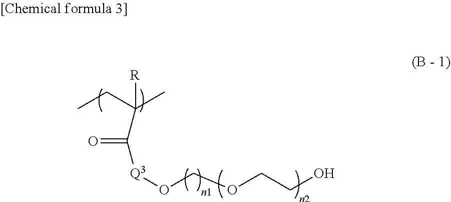

wherein R represents a hydrogen atom or a methyl group, Q³ represents a single bond or a divalent organic group, and n1 and n2 are the same as n1 and n2 respectively in the formula (1).
[6] The copolymer according to any one of [1] to [5], wherein the unit (C) is represented by formula (C-1) shown below:

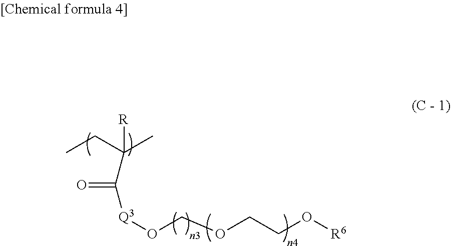

wherein R represents a hydrogen atom or a methyl group, Q³ represents a single bond or a divalent organic group, and R⁶, n3 and n4 are the same as R⁶, n3 and n4 respectively in the formula (2).
[7] The copolymer according to any one of [1] to [6], wherein the unit (A) is represented by formula (A-1) shown below:

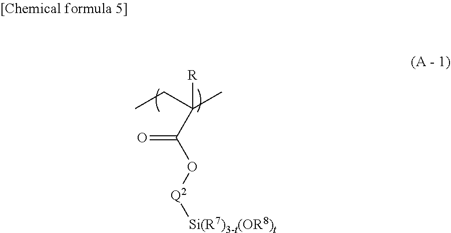

wherein R represents a hydrogen atom or a methyl group, Q² represents a divalent organic group, R⁷ represents an alkyl group of 1 to 18 carbon atoms, R⁸ represents a hydrogen atom or an alkyl group of 1 to 18 carbon atoms, t represents an integer of 1 to 3, and when a plurality of R⁷ or R⁸ groups exist, the plurality of R⁷ or R⁸ may be the same or different.
[8] The copolymer according to any one of [1] to [7], further having a unit (D) having a polyoxyethylene chain that constitutes the main chain.
[9] The copolymer according to [8], wherein the unit (D) is represented by formula (D1) or (D2) shown below:

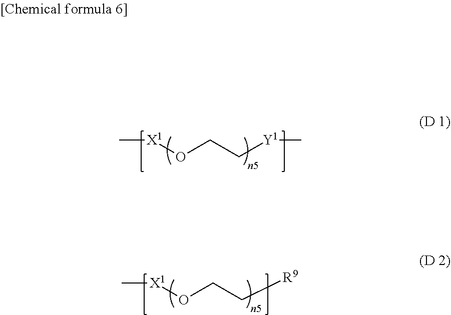

wherein n5 represents an integer of 10 to 200, X¹ and Y¹ each independently represent a divalent group represented by formula (3) or (4) shown below, and R⁹ represents a hydroxyl group, methoxy group or ethoxy group,

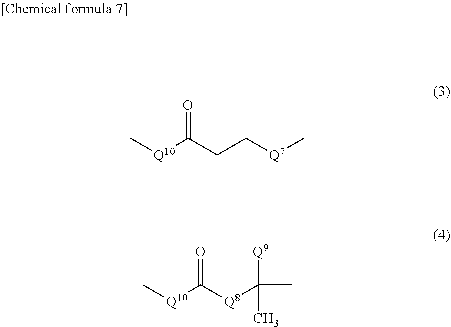

wherein Q⁷ represents a divalent organic group, Q⁸ represents a single bond or an alkylene group of 1 to 5 carbon atoms, Q⁹ represents a cyano group or a methyl group, Q¹⁰ represents a single bond when the divalent group represented by formula (3) or (4) is X¹, and represents an oxygen atom when the divalent group represented by formula (3) or (4) is Y¹, and
when the divalent group represented by formula (3) or (4) is X¹, the Q¹⁰-side terminal is bonded to the oxygen atom adjacent to X¹, whereas when the divalent group represented by formula (3) or (4) is Y¹, the Q¹⁰-side terminal is bonded to the carbon atom adjacent to Y¹.
   [10] The copolymer according to [9], wherein the unit (D) is a unit represented by the formula (D1), and X¹ and Y¹ in the formula (D1) each independently represent a divalent group represented by the formula (3).
   [11] A composition containing the copolymer according to any one of [1] to [10].
   [12] The composition according to [11], also containing a liquid medium.
   [13] An article having a substrate and a surface layer provided on the substrate, wherein the surface layer is formed from a cured product of the composition according to [11] or [12].
   [14] The article according to [13], wherein the article is a medical device.

The copolymer of the present invention is capable of forming a surface layer having excellent non-adsorptivity.

The composition of the present invention is capable of forming a surface layer having excellent non-adsorptivity.

The article of the present invention exhibits excellent non-adsorptivity.

### DETAILED DESCRIPTION OF THE INVENTION

The meanings and definitions of the terminology used in the present invention are as follows.

The term “(meth)acrylate” is a generic term for acrylate and methacrylate.

A “unit based on a monomer” means a portion derived from that monomer and formed by polymerization of the monomer.

The term “biocompatible group” means a group having a property that inhibits adhesion and immobilization of biological components such as blood, cells and proteins on the surface of a material.

In this description, a compound, group, structure or unit represented by a chemical formula is sometimes described as a compound, group, structure or unit with the number of the formula appended thereto. For example, a compound represented by formula 1 may be referred to as “compound 1”, or a structure represented by formula 1 may be referred to a “structure 1”.

A numerical range represented by the expression “a to b” means a range in which the numbers before and after the “to” are included within the range as the lower limit and upper limit respectively.

### (Copolymer)

The copolymer according to one embodiment of the present invention (hereinafter also referred to as a “copolymer of the present invention”) includes a unit (A) described below, a unit (B) described below, and a unit (C) described below.

The copolymer of the present invention may, if necessary, also include a unit (D) described below.

The copolymer of the present invention may, if necessary, also include another unit besides the unit (A), the unit (B), the unit (C) and the unit (D).

### <Unit (A)>

The unit (A) has a reactive silyl group.

The term “reactive silyl group” is a generic term for hydrolyzable silyl groups such as alkoxysilyl groups and a silanol group. Hydrolyzable silyl groups undergo a hydrolysis reaction to form a silanol group (Si—OH). The silanol groups formed by hydrolysis of the hydrolyzable silyl group in those cases where the reactive silyl group is a hydrolyzable silyl group, or the reactive silyl groups themselves in those cases where the reactive silyl group is a silanol group, undergo a dehydration-condensation reaction to form a siloxane linkage (Si—O—Si), thus forming a cured product.

The reactive silyl group is preferably an alkoxysilyl group, and examples include the group (5) shown below.

—Si(R⁷)₃₋ₜ(OR⁸)ₜ Formula (5)

In the formula, R⁷ represents an alkyl group of 1 to 18 carbon atoms, R⁸ represents a hydrogen atom or an alkyl group of 1 to 18 carbon atoms, and t represents an integer of 1 to 3.

In those cases where a plurality of R⁷ or R⁸ groups exist, the plurality of R⁷ or R⁸ may be the same or different. From the viewpoint of production, the plurality of R⁷ or R⁸ groups are preferably the same.

From the viewpoint of the adhesion between the substrate and the surface layer, t is preferably 2 or greater, and is more preferably 3.

From the viewpoint of limiting steric hindrance during the dehydration-condensation reaction, R⁷ is preferably an alkyl group of 1 to 6 carbon atoms, and more preferably a methyl group or an ethyl group.

From the viewpoints of the reaction rate of the hydrolysis reaction and the volatility of the by-products produced during the hydrolysis reaction, R⁸ is preferably an alkyl group of 1 to 6 carbon atoms, and more preferably a methyl group or an ethyl group.

Examples of the unit (A) include the unit (A-1).

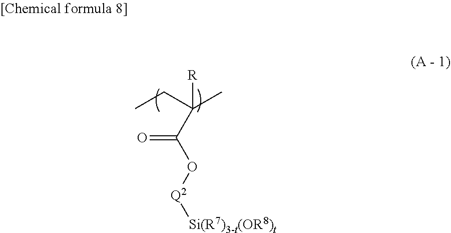

In the formula, R represents a hydrogen atom or a methyl group, Q² represents a divalent organic group, and R⁷, R⁸ and t are the same as R⁷, R⁸ and t respectively in formula (5) above.

Q² is preferably a divalent hydrocarbon group of 2 to 10 carbon atoms. The divalent hydrocarbon group may have an etheric oxygen atom between carbon atoms, and one or more hydrogen atoms may each be substituted with a halogen atom or a hydroxyl group. Examples of the halogen atom include a chlorine atom and a fluorine atom.

Q² is preferably —C₂H₄—, —C₃H₆— or —C₄H₈—, is more preferably —C₃H₆— or —C₄H₈—, and is even more preferably —C₃H₆—.

The unit (A) may be a unit based on a (meth)acrylate (a-1).

CH₂═CR—COO-Q²-Si(R⁷)₃₋ₜ(OR⁸)ₜ Formula (a-1)

Examples of the (meth)acrylate (a-1) include CH₂═CR—COO—(CH₂)₃—Si(OCH₃)₃ and CH₂═CR—COO—(CH₂)₃—Si(OC₂H₅)₃.

### <Unit (B)>

The unit (B) has a group (1).

The group (1) functions as a biocompatible region. The existence of the group (1) inhibits adhesion and immobilization of biological components such as cells and proteins on material surfaces, and generates non-adsorptivity.

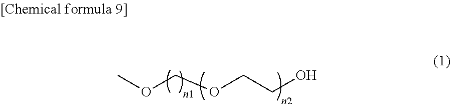

In the formula, n1 represents 2 or 3, and n2 represents an integer of 0 to 300.

In terms of achieving superior water resistance, n2 is preferably 8 or less, more preferably 3 or less, and even more preferably 0.

Examples of the unit (B) include the unit (B-1).

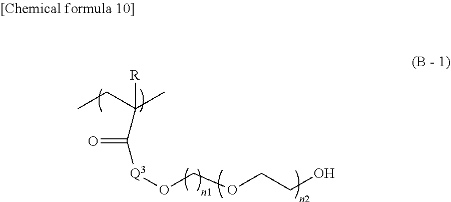

In the formula, R represents a hydrogen atom or a methyl group, Q³ represents a single bond or a divalent organic group, and n1 and n2 are the same as n1 and n2 respectively in formula (1) above.

Examples of the divalent organic group for Q³ include —O-Q⁶-. Here, Q⁶ represents a divalent organic group. In those cases where Q³ represents —O-Q⁶-, the —O-side terminal of —O-Q⁶- is bonded to the carbonyl group adjacent to Q³.

Examples of Q⁶ include the same groups as those exemplified above for Q² in the formula (A-1).

Q³ is preferably a single bond.

The unit (B-1) may be a unit based on a (meth)acrylate (b-1).

CH₂═CR—CO-Q³-O—(CH₂)ₙ₁—(OCH₂CH₂)ₙ₂—OH Formula (b-1)

### <Unit (C)>

The unit (C) has a group (2).

In a similar manner to the group (1), the group (2) functions as a biocompatible region.

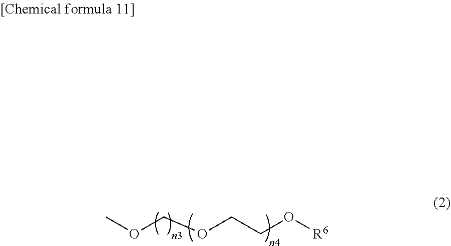

In the formula, R⁶ represents an alkyl group, n3 represents 2 or 3, n4 represents an integer of 0 to 300, and a ratio represented by (n4+1)/(number of carbon atoms in R⁶) is at least 0.5 but less than 9.

R⁶ may be linear or branched, but is preferably linear. In terms of achieving superior non-adsorptivity, the number of carbon atoms in R⁶ is preferably within a range from 1 to 22, more preferably from 1 to 5, and even more preferably 1 or 2.

Further, n4 may be any value that yields a ratio represented by (n4+1)/(number of carbon atoms in R⁶) of at least 0.5 but less than 9, but in terms of achieving superior water resistance, n4 is preferably within a range from 0 to 100, more preferably from 0 to 39, and even more preferably from 0 to 7.

Provided the ratio represented by (n4+1)/(number of carbon atoms in R⁶) is at least 0.5, excellent non-adsorptivity is achieved, whereas provided the ratio is less than 9, a combination of excellent non-adsorptivity and water resistance can be achieved. The ratio represented by (n4+1)/(number of carbon atoms in R⁶) is preferably 8 or less, and more preferably 6 or less.

In the group (2), it is preferable that R⁶ represents an alkyl group of 1 to 5 carbon atoms and n4 is an integer of 0 to 39.

Among the various possibilities, the group (2) is preferably a group in which n3 is 3, n4 is 0 and R⁶ represents a methyl group, or n3 is 2, n4 is an integer of 0 to 7, and R⁶ represents a methyl group or an ethyl group. In other words, the group (2) is preferably —O—(CH₂)₃—OCH₃, —O—(CH₂)₂—(O(CH₂)₂)ₙ₂—OCH₃, or —O—(CH₂)₂—(O(CH₂)₂)ₙ₂—OC₂H₅. In terms of the water resistance, when n3 is 2, n4 is preferably 6 or less, and more preferably 5 or less.

Examples of the unit (C) include the unit (C-1).

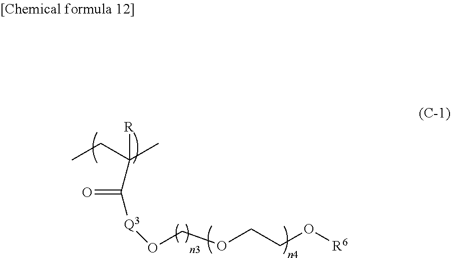

In the formula, R represents a hydrogen atom or a methyl group, Q³ represents a single bond or a divalent organic group, and n3, n4 and R⁶ are the same as n3, n4 and R⁶ respectively in the formula (2) above.

Examples of the divalent organic group for Q³ in formula (C-1) include the same groups as those exemplified above for the divalent organic group for Q³ in formula (B-1).

In those cases where the unit (B) includes the unit (B-1) and the unit (C) includes the unit (C-1), R and Q³ in the unit (C-1) may be the same as, or different from, R and Q³ respectively in the unit (B-1).

The unit (C-1) may be a unit based on a (meth)acrylate (c-1).

CH₂═CR—CO-Q³-O—(CH₂)ₙ₃—(OCH₂CH₂)ₙ₄—OR⁶ Formula (c-1)

### <Unit (D)>

The unit D has a polyoxyethylene chain that constitutes the main chain of the copolymer of the present invention.

In a similar manner to the group (1) of the unit (B) and the group (2) of the unit (C), the polyoxyethylene chain of the unit (D) functions as a biocompatible region.

Examples of the unit (D) include the unit (D1) or the unit (D2).

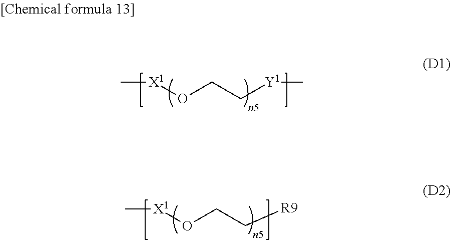

In the formulas, n5 represents an integer of 10 to 200, X¹ and Y¹ each independently represent a divalent group (3) or (4), and R⁹ represents a hydroxyl group, methoxy group or ethoxy group.

Further, n5 is preferably an integer of 40 to 200, and more preferably an integer of 40 to 140.

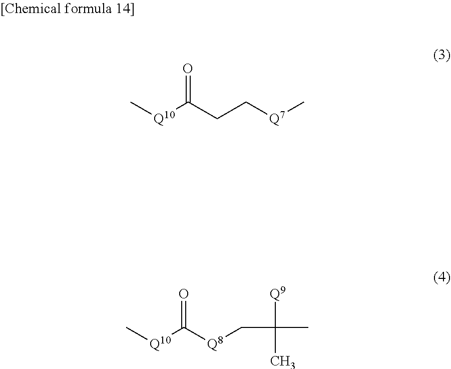

In the formulas, Q⁷ represents a divalent organic group, Q⁸ represents a single bond or an alkylene group of 1 to 5 carbon atoms, and Q⁹ represents a cyano group or a methyl group. Q¹⁰ represents a single bond when the divalent group (3) or (4) is X¹, and represents an oxygen atom when the divalent group (3) or (4) is Y¹.

When the divalent group (3) or (4) is X¹, the Q¹⁰-side terminal is bonded to the oxygen atom adjacent to X¹, whereas when the divalent group (3) or (4) is Y¹, the Q¹⁰-side terminal is bonded to the carbon atom adjacent to Y¹. In other words, in the unit (D1), the Q¹⁰ groups of the divalent groups (3) or (4) are bonded to the oxygen atom-side terminal and the carbon atom-side terminal respectively of the polyoxyethylene chain (OCH₂CH₂)ₙ₅. Similarly, in the unit (D2), Q¹⁰ of the divalent group (3) or (4) is bonded to the oxygen atom-side terminal of the polyoxyethylene chain (OCH₂CH₂)ₙ₅.

Q⁷ is preferably a divalent hydrocarbon group of 2 to 10 carbon atoms. The divalent hydrocarbon group may have an etheric oxygen atom between carbon atoms, and one or more hydrogen atoms may each be substituted with a halogen atom, a hydroxyl group or a cyano group. Examples of the halogen atom include a chlorine atom and a fluorine atom.

Q⁷ is preferably —C(CH₃)(COOC₂H₅)—, —C(CH₃)(COOCH₃)—, or —C(CH₃)(CN)—, is more preferably —C(CH₃)(COOCH₃)— or —C(CH₃)(CN)—, and is even more preferably —C(CH₃)(CN)—.

The alkylene group for Q⁸ may be linear or branched, but is preferably linear.

In terms of being more readily available, the unit (D) is preferably a unit (D1-1) in which X¹ and Y¹ each independently represent the divalent group (3). In such cases, the two Q⁷ groups in the unit (D1-1) may be the same or different.

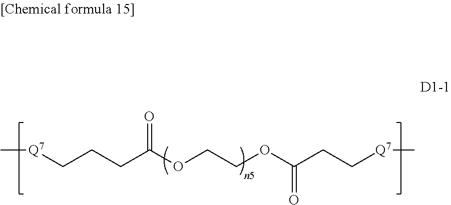

The unit (D) may be, for example, a unit based on a monomer containing a polyoxyethylene chain and having radical polymerizable groups at both terminals, or may be a unit based on a polymerization initiator containing a polyoxyethylene chain and a radical-generating site such as an azo group (—N═N—). A unit based on an the above-mentioned polymerization initiator is preferred in terms of enabling simple introduction of the polyoxyethylene chain into the main chain of the copolymer.

Examples of polymerization initiators containing a polyoxyethylene chain and a radical-generating site include azo-based polymerization initiators having a polyoxyethylene chain. Specific examples include compounds having a structure (PI). Examples of compounds having the structure (PI) include the product VPE-0201 manufactured by FUJIFILM Wako Pure Chemical Corporation.

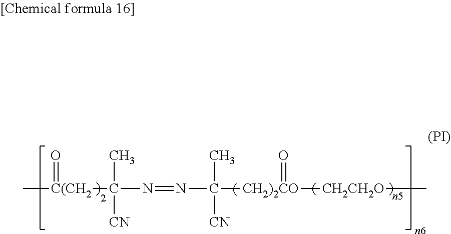

In the formula (PI), n5 is the same as n5 in formula (D1) or (D2), and n6 represents an integer of 1 to 100. Further, n6 is preferably within a range from 2 to 30, and more preferably from 3 to 20.

### <Other Units>

Examples of other units include units having a biocompatible group (but excluding the unit (B), the unit (C) and the unit (D)), and units based on monomers having neither a biocompatible group nor a reactive silyl group.

Examples of units having a biocompatible group (but excluding the unit (B), the unit (C) and the unit (D)) include units represented by formula (B2) or (B3) disclosed in International Patent Publication No. 2019/198374.

Examples of units based on monomers having neither a biocompatible group nor a reactive silyl group include units represented by formula (C) disclosed in International Patent Publication No. 2019/198374.

The proportion of the unit (A) relative to the total of all the units that constitute the copolymer of the present invention is preferably within a range from 0.1 to 50% by mass, more preferably from 1.0 to 30% by mass, and even more preferably from 3 to 25% by mass. Provided the proportion of the unit (A) is at least as high as the above lower limit, the durability, water resistance and wear resistance are superior, whereas provided the proportion is not more than the above upper limit, the non-adsorptivity is particularly superior.

The proportion of the combined total of the unit (B) and the unit (C) relative to the total of all the units that constitute the copolymer of the present invention is preferably within a range from 40 to 99.9% by mass, more preferably from 50 to 99% by mass, and even more preferably from 60 to 97% by mass. Provided the proportion of the combined total of the unit (B) and the unit (C) is at least as high as the above lower limit, the non-adsorptivity is particularly superior, whereas provided the proportion is not more than the above upper limit, the durability of the non-adsorptivity, the water resistance, and the wear resistance are superior.

The proportion of the unit (B) relative to the combined total of the unit (B) and the unit (C) is preferably within a range from 0.1 to 90% by mass, more preferably from 10 to 90% by mass, and even more preferably from 30 to 90% by mass. Provided the proportion of the unit (B) falls within this range, the non-adsorptivity and the water resistance are particularly superior.

The proportion of the combined total of the unit (B) and the unit (C) relative to the combined total of the unit (B), the unit (C) and the unit (D) is preferably at least 50 mol % by mass and more preferably at least 70 mol %, and may be 100 mol %.

The proportion of the combined total of the unit (A), the unit (B), the unit (C) and the unit (D) relative to the total of all the units that constitute the copolymer of the present invention is preferably at least 50% by mass and more preferably at least 75% by mass, and may be 100% by mass.

In terms of ease of production, the weight average molecular weight (hereinafter also abbreviated as “Mw”) of the copolymer of the present invention is preferably within a range from 1,000 to 1,000,000, and more preferably from 20,000 to 100,000. The Mw value can be calculated by size exclusion chromatography.

The copolymer of the present invention can be produced by conventional methods, such as the methods disclosed in International Patent Publication No. 2019/198374. For example, by polymerizing monomer components including the (meth)acrylate (a-1), the (meth)acrylate (b-1) and the (meth)acrylate (c-1) in the presence of a polymerization initiator, a copolymer having the unit (A), the unit (B) and the unit (C) can be obtained. At this time, by also including a monomer having a polyoxyethylene chain and having radical polymerizable groups at both terminals, or by using a polymerization initiator having a polyoxyethylene chain and a radical-generating site as the polymerization initiator, a copolymer having the unit (A), the unit (B), the unit (C) and the unit (D) can be obtained.

By using the copolymer of the present invention, a surface layer having excellent non-adsorptivity can be formed.

When the copolymer has only the unit (B) among the unit (B) and the unit (C), the non-adsorptivity tends to be inferior to the case where the copolymer has only the unit (C). However, by incorporating a combination of the unit (B) and the unit (C), the non-adsorptivity improves beyond that achievable with only the unit (C), and the water resistance also improves.

In the case with only the unit (C), it is thought that when hydration occurs, the switch between hydrophobic portions and hydrophilic portions is slow, meaning the non-adsorptivity effect of the unit (C) does not manifest satisfactorily.

The hydrophobic α-position methyl group of the unit (B) has low surface tension, is segregated at the air interface, and has a weak cohesive force. Accordingly, it is thought that by using a combination of the unit (B) with the unit (C), the cohesive force can be reduced without inhibiting the non-adsorptivity, and a more rapid switch to the hydrophilic portion of the unit (C) can be achieved upon hydration.

### (Composition)

The composition according to one embodiment of the present invention (hereinafter also referred to as a “composition of the present invention” contains the copolymer of the present invention. A single copolymer of the present invention or two or more such copolymers may be included in the composition of the present invention.

The composition of the present invention may also contain other components besides the copolymer of the present invention. Examples of these other components include other solid components besides the copolymer of the present invention that may be incorporated as solid matter in the cured product of the composition of the present invention, and liquid mediums.

In those cases where the composition of the present invention is used for forming a surface layer described below, and that surface layer is formed by a dry coating method, the composition of the present invention contains only solid components. On the other hand, when the surface layer is formed by a wet coating method, the composition also includes a liquid medium as another component, which is then removed during the formation of the surface layer.

The above-mentioned other solid components may be components which cure in a similar manner to the copolymer of the present invention or may be non-curable components. Examples of these other solid components include impurities, catalysts or functional additives that represent raw materials or by-products from the production process for the copolymer of the present invention that have been unable to be completely removed; compounds having either one or both of the group (1) and the group (2) but having no reactive silyl group; compounds having biocompatible regions other than the group (1) or the group (2); and compounds having a reactive silyl group.

In terms of the catalyst, any conventional catalyst used in the hydrolysis condensation reaction of a reactive silyl group may be used without any particular limitations. Specific examples of such catalysts include acids such as hydrochloric acid, nitric acid, acetic acid, sulfuric acid, phosphoric acid, and sulfonic acids such as methanesulfonic acid and p-toluenesulfonic acid; bases such as sodium hydroxide, potassium hydroxide and ammonia; and aluminum-based or titanium-based metal catalysts.

Examples of the functional additives include ultraviolet absorbers, photostabilizers, antioxidants, leveling agents, surfactants, antimicrobial agents, dispersants, and inorganic fine particles.

Examples of the compounds having either one or both of the group (1) and the group (2) but having no reactive silyl group include (meth)acrylate homopolymers having the group (1) or the group (2).

The liquid medium may be selected appropriately from various conventional liquid mediums. The liquid medium is preferably a medium capable of uniformly dissolving or dispersing the solid components including the copolymer of the present invention.

The liquid medium must be removed eventually during formation of a cured product, and therefore the boiling point of the medium is preferably within a range from 60 to 160° C., and more preferably from 60 to 120° C.

Specific examples of preferred liquid mediums include alcohols, ethers, ketones and esters. Specific examples of liquid mediums that satisfy the above boiling point condition include isopropyl alcohol, ethanol, propylene glycol monomethyl ether, 2-butanone, and ethyl acetate. One of these liquid mediums may be used alone, or a combination of two or more mediums may be used.

The liquid medium may contain water in order to facilitate the hydrolysis reaction of the reactive silyl group-containing components such as the copolymer of the present invention, but from the viewpoint of storage stability, the liquid medium preferably contains no water. Even when the liquid medium does not contain water, the reactive silyl group-containing components can undergo a hydrolysis reaction via moisture in the atmosphere.

In terms of the non-adsorptivity, the durability of the non-adsorptivity, the water resistance and the wear resistance, the amount of the copolymer of the present invention in the composition of the present invention, relative to the total of all the solid components, is preferably at least 30% by mass, more preferably at least 50% by mass, and even more preferably 70% by mass or greater, and may be 100% by mass.

In those cases where the composition of the present invention contains a catalyst, the amount of the catalyst, relative to the amount of the copolymer of the present invention, is preferably within a range from 0.01 to 20% by mass, and more preferably from 0.1 to 5% by mass.

In those cases where the composition of the present invention contains a liquid medium, the solid component concentration within the composition of the present invention, relative to the total mass of the composition, is preferably within a range from 0.01 to 50% by mass, and more preferably from 0.1 to 30% by mass. Provided the solid component concentration falls within this range, the thickness of the surface layer formed by wet coating using the composition of the present invention is more likely to fall within the ideal range that ensures satisfactory non-adsorptivity and satisfactory durability of that non-adsorptivity.

The solid component concentration of the composition of the present invention can be calculated from the mass following vacuum drying of the composition of the present invention for 3 hours at 80° C., and the mass of the composition prior to the heating. The solid component concentration of the composition of the present invention may also be calculated from the total amount of solid components added and the amount of the liquid medium used during production of the composition.

In those cases where the composition of the present invention contains a liquid medium, the amount of the liquid medium, relative to the total mass of the composition, is preferably within a range from 50 to 99.99% by mass, and more preferably from 70 to 99.9% by mass.

There are no particular limitations on the method used for producing the composition of the present invention. The method involves mixing the solid components including the copolymer of the present invention, or the solid components and the liquid medium in those cases where the composition also includes a liquid medium.

The copolymer of the present invention in the composition of the present invention may be subjected to partial hydrolysis co-condensation and exist as a partial hydrolysis co-condensate. The copolymer of the present invention and a reactive silane compound not having a biocompatible region may also be subjected to partial hydrolysis co-condensation to form a partial hydrolysis co-condensate. In the case of partial hydrolysis condensation, the degree of condensation is controlled appropriately so that, as described below, the resulting viscosity does not impede the formation of the surface layer on the substrate.

From the viewpoint of this viscosity, the Mw of the partial hydrolysis condensate is preferably within a range from 2,000 to 2,000,000, and more preferably from 30,000 to 300,000.

### (Article)

The article according to one embodiment of the present invention (hereinafter also referred to as an “article of the present invention”) has a substrate and a surface layer provided on that substrate. The surface layer is formed from a cured product of the composition of the present invention.

The expression that the surface layer is “formed from a cured product of the composition of the present invention” means that the surface layer contains at least a cured product of a reactive silyl group-containing component that includes the copolymer of the present invention.

There are no particular limitations on the constituent material of the substrate. Specific examples of the constituent material of the substrate include metals, resins, glass, and composite materials composed of two or more of these materials. The substrate material may be selected appropriately in accordance with the intended use. From the viewpoint of adhesion with the surface layer, the constituent material of the substrate is preferably material in which the surface of a molded body formed from the material has hydroxyl groups, and glass is ideal. In those cases where the surface of the substrate does not have hydroxyl groups, hydroxyl groups are preferably introduced using a conventional method, for example, a physical treatment method such as a corona treatment or a chemical treatment method such as a primer treatment. Further, at least some or all of the surface on which the surface layer is provided is formed from the above material, but not all of the surface need be formed from the material.

Examples of preferred primer treatments include a method that uses a compound having an alkoxysilyl group such as tetraethoxysilane or a partial hydrolysis condensate thereof, and a method that uses a metal oxide such as silica. The method used for the primer treatment may employ either wet coating or dry coating.

The thickness of the surface layer is preferably within a range from 10 to 100,000 nm, and particularly preferably from 10 to 10,000 nm. Provided the thickness of the surface layer is at least a large as the above lower limit, satisfactory non-adsorptivity, durability of that non-adsorptivity and water resistance can be more easily realized. Provided the thickness is not more than above upper limit, the strength is superior.

The thickness of the surface layer can be determined by measurement with an X-ray reflectometer typified by ATX-G manufactured by Rigaku Corporation.

The article of the present invention can be obtained by forming a surface layer on the surface of a substrate using the composition of the present invention.

Examples of the method used for forming the surface layer include dry coating methods such as vacuum deposition methods, CVD methods and sputtering methods, or wet coating methods, and wet coating methods are preferred.

Examples of methods for forming the surface layer by wet coating include methods including a step of obtaining a coating film by applying an the composition of the present invention containing a liquid medium described above to a substrate (hereinafter also referred to as the “coating step”), and a step of obtaining the surface layer by curing the coating film (hereinafter also referred to as the “curing step”).

Examples of the method used for applying the composition of the present invention in the coating step include dip coating methods, spin coating methods, wipe coating methods, spray coating methods, squeegee coating methods, die coating methods, inkjet methods, flow coating methods, roller coating methods, casting methods, the Langmuir project method, and gravure coating methods.

The method used for curing the coating film on the curing step is preferably a heating method. The heating temperature varies depending on the type of the reactive silyl group-containing components including the copolymer of the present invention, but the temperature is preferably within a range from 50 to 150° C., and more preferably from 100 to 150° C. In the curing step, removal of the liquid medium is typically conducted at the same time as the curing. Accordingly, the heating temperature is preferably at least as high as the boiling point of the liquid medium. However, in those cases where heated drying is problematic due to the material or the like of the substrate, removal of the liquid medium may be conducted without heating. For example, drying under reduced pressure may be used.

The formation of the surface layer by wet coating may also include processing steps other than the coating step and the curing step if necessary. For example, in those cases where the composition of the present invention contains no water, a humidification treatment or the like may be conducted either at the same time as the curing step, or before or after the curing step.

Furthermore, following formation of the surface layer, compounds in the surface layer that are excess to requirements may be removed if necessary. Examples of specific methods that may be used include methods in which a solvent, for example the compound used as the liquid medium in the composition of the present invention, is flowed across the surface layer, and methods in which the surface layer is wiped with a cloth soaked in a solvent, for example the compound used as the liquid medium in the composition of the present invention.

The composition of the present invention can also be used as a repair agent to treat degradation of the surface layer. In such cases, the coating method used is preferably a wet coating method such as spray coating or brush coating. The curing method preferably involves heating using a dryer or the like.

Although there are no particular limitations on the applications of the article of the present invention, because the article exhibits excellent non-adsorptivity, durability of that non-adsorptivity, water resistance and wear resistance, an article having a surface that comes into contact with biological components such as blood and proteins is preferred. Examples of specific articles include medical devices such as endoscopes, catheters, medical treatment tools, artificial blood vessels, artificial joints, respiratory bags, artificial heart lung machines, tubes, stents, chips, ampules, vials, syringes, needles, and protein 3D printing tools; bioanalytical equipment members such as needles, chips and vials; and scientific equipment such as Petri dishes, plates, vials and chips. Among these articles, in terms of coming into regular contact with biological components, medical devices are ideal.

### Examples

The present invention is described below in further detail using a series of examples and comparative examples, but the invention is not limited to the following examples, provided the scope of the invention is not exceeded. The unit “wt %” is used with the same meaning as “% by mass”.

Examples 1 to 8 and 15 to 21 are examples of the present invention, and Examples 9 to 14 are comparative examples.

### (Evaluation Methods)

### <Amount of Protein Adsorption>

To a 0.5 g sample of a copolymer solution with a solid component concentration of 20 wt % obtained in each example were added 0.9 g of a mixed solvent prepared by mixing methoxypropanol and diacetone alcohol in a ratio of 85:15 (mass ratio) and 0.6 g of a 0.1 wt % aqueous solution of nitric acid, and the resulting mixture was stirred at 50° C. for 16 hours. Subsequently, 1.33 g of the mixed solvent prepared by mixing methoxypropanol and diacetone alcohol in a ratio of 85:15 (mass ratio) was added, thus obtaining a coating solution with a solid component concentration of 3 wt %.

Next, 2 mL of the thus obtained coating solution was added dropwise to a 20 mL glass vial, and the glass vial was rotated to spread the coating solution over the inner surface of the vial and form a film. Subsequently, the glass vial was inverted and left to stand for 5 minutes, and was then subjected to a heat treatment in an oven at 150° C. for 30 minutes to cure the film.

Subsequently, 1 mL of a human fibrinogen (hFbn) solution prepared at a concentration of 1 mg/mL was added to the thus obtained film-coated glass vial, and after holding the vial at 37° C. for 30 minutes, the glass vial was washed using a phosphate buffer solution (PBS) containing 0.05 wt % of dissolved Tween20 (manufactured by Sigma-Aldrich Corporation). Next, 1 mL of a 0.1 N aqueous solution of NaOH containing 5 wt % of sodium dodecyl sulfate (SDS) was added to the glass vial, and the glass vial was held at 37° C. for 2 hours to extract the proteins adsorbed to the film inside the glass vial into the aqueous phase. Subsequently, 1 mL of a micro BCA reagent (manufactured by Thermo Scientific Inc.) was added to the glass vial, and the vial was held at 37° C. for 2 hours to ensure satisfactory coloration. Next, 180 μL of the solution in the glass vial was transferred to a 96-well TCPS plate, and a microplate reader was used to measure the absorbance of light of 560 nm. Using a calibration curve created using the absorbance measurements of protein solutions of known concentrations, the mass (mg/mL) of protein within the 0.1 N aqueous solution of NaOH containing 5 wt % of sodium dodecyl sulfate (SDS) and the micro BCA reagent was determined. A smaller mass of protein indicates superior non-adsorptivity.

### <Water Resistance>

To a 0.5 g sample of a copolymer solution with a solid component concentration of 20 wt % obtained in each example were added 0.9 g of a mixed solvent prepared by mixing methoxypropanol and diacetone alcohol in a ratio of 85:15 (mass ratio) and 0.6 g of a 0.1 wt % aqueous solution of nitric acid, and the resulting mixture was stirred at 50° C. for 16 hours. Subsequently, 1.33 g of the mixed solvent prepared by mixing methoxypropanol and diacetone alcohol in a ratio of 85:15 (mass ratio) was added, thus obtaining a coating solution with a solid component concentration of 3 wt %.

Next, 200 mL of the thus obtained coating solution was dripped onto a 3 cm square silicon wafer, and the silicon wafer was rotated at 1,000 rpm for 30 seconds to form a film on the wafer. The obtained film-coated silicon wafer was washed with pure water, and impurities including low-molecular weight components on the film surface were washed away. Using an F20-UV device manufactured by Filmetrics Inc., the thickness of the film was measured, and this value was deemed the initial thickness.

Subsequently, the film-coated silicon wafer was immersed for 30 days in 200 mL of a physiological saline solution (D-PBS (−)). After the 30 days, the film-coated silicon was removed and dried on a hot plate at 40° C. for 30 minutes. Following drying, the thickness of the film was measured using the F20-UV device, and this value was deemed the thickness following water resistance testing, with the reduction in film thickness then calculated using the formula below. A reduction in film thickness of less than 5% was deemed to indicate favorable water resistance (shown as “o” in Table 1), whereas a reduction of 5% or greater was deemed to indicate poor water resistance (shown as “×” in Table 1).

Reduction in film thickness (%)=(initial thickness(μm)−thickness following water resistance testing(μm))/initial thickness(μm)×100

### (Monomers)

KBM503: 3-methacryloxypropyltrimethoxysilane (CH₂═C(CH₃)—COO—(CH₂)₃—Si(OCH₃)₃, molecular weight: 248.4, “KBM-503” manufactured by Shin-Etsu Silicones, Inc.)
HEMA: hydroxyethyl methacrylate (CH₂═C(CH₃)—COO—CH₂CH₂O—H, molecular weight 130.14)
HEEMA: 2-(2-hydroxyethoxy)ethyl methacrylate (CH₂═C(CH₃)—COO—CH₂CH₂O—CH₂CH₂—OH, molecular weight 174.09)
HEEEMA: 2-(2-(2-hydroxyethoxy)ethoxy)ethyl methacrylate (CH₂═C(CH₃)—COO—CH₂CH₂O—CH₂CH₂O—CH₂CH₂—OH, molecular weight 218.12)
MEA: methoxyethyl acrylate (CH₂═CH—COO—CH₂CH₂O—CH₃, molecular weight 130.14, ratio represented by (n4+1)/(number of carbon atoms in R⁶) in formula (2)=1)
PEG3A: polyethylene glycol acrylate with three repeating EO units (CH₂═CH—COO—(CH₂CH₂O)₃—CH₃, molecular weight: 232.3, ratio represented by (n4+1)/(number of carbon atoms in R⁶) in formula (2)=3)
PEG9A: polyethylene glycol acrylate with 9 repeating oxyethylene (EO) units (CH₂═CH—COO—(CH₂CH₂O)₉—CH₃, molecular weight: 496.6, ratio represented by (n4+1)/(number of carbon atoms in R⁶) in formula (2)=9)

### (Polymerization Initiator)

VPE0201: an azo-based polymerization initiator having a polyoxyethylene chain (a compound having a structure of the above formula (PI) in which n5 is 45 to 46, and n6 is from 6 to 14, molecular weight: 2240, “VPE-0201” manufactured by FUJIFILM Wako Pure Chemical Corporation)

### Examples 1 to 6, and 9 to 21

The components shown in Table 1 were dissolved in the proportions (wt %) shown in Table 1 in a mixed solvent prepared by mixing methoxypropanol and diacetone alcohol in a ratio of 85:15 (mass ratio) to generate a solution with a solid component concentration of 20 wt %. The thus obtained solution was placed in a pressure-resistant glass bottle, and following sealing of the bottle, a polymerization was conducted by heating the bottle at 80° C. for 24 hours, thus yielding a copolymer solution with a solid component concentration of 20 wt %.

### Examples 7 and 8

With the exception of using azobisisobutyronitrile as the polymerization initiator instead of VPE0201, the same procedure as Examples 1 to 6 and 9 to 21 was used to obtain copolymer solutions with a solid component concentration of 20 wt %.

Each of the obtained copolymer solutions was subjected to the evaluations described above. The results are shown in Table 1.

The copolymer solution of each example was subjected to the evaluations described above. The results are shown in Table 1.

Table 1 also shows the proportion (wt %) of the unit (B) relative to the combined total of the unit (B) and the unit (C), and the proportion (mol %) of the combined total of the unit (B) and the unit (C) relative to the combined total of the unit (B), the unit (C) and the unit (D).

TABLE 1

| | Proportions (wt %) | | | | | | | | |
|---|---|---|---|---|---|---|---|---|---|
| | (A) | (B) | | | (C) | | (D) | Other | |
| | KBM503 | HEMA | HEEMA | HEEEMA | MEA | PEG3A | VPE0201 | PEG9A | AIBN |
| Example 1 | 10 | 30 | 0 | 0 | 40 | 0 | 20 | 0 | 0 |
| Example 2 | 10 | 35 | 0 | 0 | 35 | 0 | 20 | 0 | 0 |
| Example 3 | 10 | 50 | 0 | 0 | 20 | 0 | 20 | 0 | 0 |
| Example 4 | 10 | 10 | 0 | 0 | 60 | 0 | 20 | 0 | 0 |
| Example 5 | 10 | 35 | 0 | 0 | 0 | 35 | 20 | 0 | 0 |
| Example 6 | 10 | 20 | 0 | 0 | 0 | 50 | 20 | 0 | 0 |
| Example 7 | 10 | 60 | 0 | 0 | 28 | 0 | 0 | 0 | 2 |
| Example 8 | 10 | 28 | 0 | 0 | 60 | 0 | 0 | 0 | 2 |
| Example 15 | 10 | 29 | 0 | 0 | 41 | 0 | 20 | 0 | 0 |
| Example 16 | 10 | 34 | 0 | 0 | 36 | 0 | 20 | 0 | 0 |
| Example 17 | 10 | 29 | 0 | 0 | 61 | 0 | 0 | 0 | 0 |
| Example 18 | 10 | 62 | 0 | 0 | 8 | 0 | 20 | 0 | 0 |
| Example 19 | 10 | 3 | 0 | 0 | 67 | 0 | 20 | 0 | 0 |
| Example 20 | 10 | 0 | 30 | 0 | 40 | 0 | 20 | 0 | 0 |
| Example 21 | 10 | 0 | 0 | 30 | 40 | 0 | 20 | 0 | 0 |
| Example 9 | 10 | 30 | 0 | 0 | 0 | 0 | 20 | 40 | 0 |
| Example 10 | 10 | 50 | 0 | 0 | 0 | 0 | 20 | 20 | 0 |
| Example 11 | 10 | 60 | 0 | 0 | 0 | 0 | 20 | 10 | 0 |
| Example 12 | 10 | 70 | 0 | 0 | 0 | 0 | 20 | 0 | 0 |
| Example 13 | 10 | 0 | 0 | 0 | 70 | 0 | 20 | 0 | 0 |
| Example 14 | 10 | 0 | 0 | 0 | 35 | 0 | 20 | 35 | 0 |

| | | | (B + C)/ | Evaluations | |
|---|---|---|---|---|---|
| | | B/(B + C) | (B + C + D) | Protein | |
| | | *100 | *100 | adsorption | Water |
| | Mw | (wt %) | (mol %) | (mg/ml) | Resistance |
| Example 1 | 42,000 | 43 | 98 | 0.9 | ∘ |
| Example 2 | 44,000 | 50 | 98 | 0.9 | ∘ |
| Example 3 | 38,000 | 71 | 98 | 1.2 | ∘ |
| Example 4 | 48,000 | 14 | 98 | 1.0 | ∘ |
| Example 5 | 42,000 | 50 | 98 | 1.6 | ∘ |
| Example 6 | 43,000 | 29 | 98 | 1.3 | ∘ |
| Example 7 | 52,000 | 68 | 100 | 1.3 | ∘ |
| Example 8 | 41,000 | 32 | 100 | 1.0 | ∘ |
| Example 15 | 34,000 | 41 | 98 | 0.9 | ∘ |
| Example 16 | 33,000 | 49 | 98 | 0.9 | ∘ |
| Example 17 | 37,000 | 32 | 100 | 1.0 | ∘ |
| Example 18 | 42,000 | 89 | 98 | 1.6 | ∘ |
| Example 19 | 40,000 | 4 | 98 | 1.0 | ∘ |
| Example 20 | 42,000 | 43 | 98 | 0.9 | ∘ |
| Example 21 | 45,000 | 43 | 98 | 0.9 | ∘ |
| Example 9 | 56,000 | 100 | 97 | 1.9 | x |
| Example 10 | 52,000 | 100 | 98 | 2.6 | x |
| Example 11 | 38,000 | 100 | 98 | 2.8 | ∘ |
| Example 12 | 45,000 | 100 | 98 | 3.2 | ∘ |
| Example 13 | 51,000 | 0 | 98 | 1.8 | x |
| Example 14 | 47,000 | 0 | 97 | 1.8 | x |

The films of Examples 1 to 8 and 15 to 21 exhibited excellent non-adsorptivity and water resistance.

On the other hand, Examples 9 to 11 which contained a unit based on PEG9A instead of the unit (C) exhibited inferior non-adsorptivity compared with Examples 1 to 8 and 15 to 21. In particular, Examples 9 and 10 which contained a comparatively large proportion of the unit based on PEG9A also exhibited poor water resistance.

Example 12 which did not contain the unit (C) had the worst non-adsorptivity.

Examples 13 and 14 which did not contain the unit (B) exhibited inferior non-adsorptivity compared with Examples 1 to 8 and 15 to 21, and also displayed poor water resistance.

The various compositions and combinations and the like described in each of the embodiments are merely examples, and additions, omissions, substitutions and other changes to these compositions are possible without departing from the scope of the present invention. Also, it is apparent that the present invention is not limited to the above embodiments, but may be modified and changed without departing from the scope and spirit of the invention.

What is claimed is:

1. A copolymer including a unit (A) including a reactive silyl group, a unit (B) having a group represented by formula (1) shown below, and a unit (C) represented by formula (2) shown below: 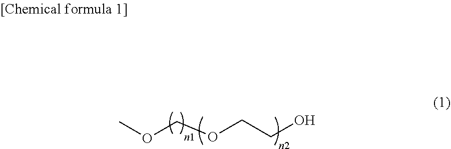
wherein n1 represents 2 or 3, and n2 represents an integer of 0 to 300, 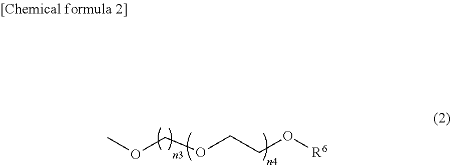
wherein R⁶ represents an alkyl group, n3 represents 2 or 3, n4 represents an integer of 0 to 300, and a ratio represented by (n4+1)/(number of carbon atoms in R⁶) is at least 0.5 but less than 9.

2. The copolymer according to claim 1, wherein a proportion of the unit (B) relative to a combined total of the unit (B) and the unit (C) is within a range from 0.1 to 90% by mass.

3. The copolymer according to claim 1, wherein n2 in the formula (1) is 0.

4. The copolymer according to claim 1, wherein in formula (2), either n3 is 3, n4 is 0 and R⁶ represents a methyl group, or n3 is 2, n4 is an integer of 0 to 7, and R⁶ represents a methyl group or an ethyl group.

5. The copolymer according to claim 1, wherein the unit (B) is represented by formula (B-1) shown below: 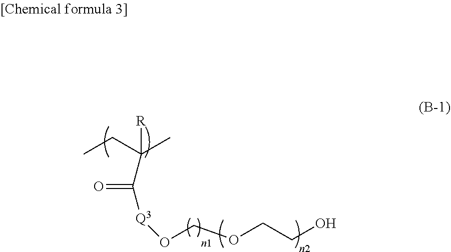
wherein R represents a hydrogen atom or a methyl group, Q³ represents a single bond or a divalent organic group, and n1 and n2 are the same as n1 and n2 respectively in the formula (1).

6. The copolymer according to claim 1, wherein the unit (C) is represented by formula (C-1) shown below: 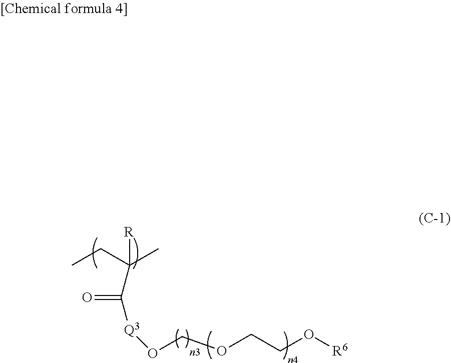
wherein R represents a hydrogen atom or a methyl group, Q³ represents a single bond or a divalent organic group, and R⁶, n3 and n4 are the same as R⁶, n3 and n4 respectively in the formula (2).

7. The copolymer according to claim 1, wherein the unit (A) is represented by formula (A-1) shown below: 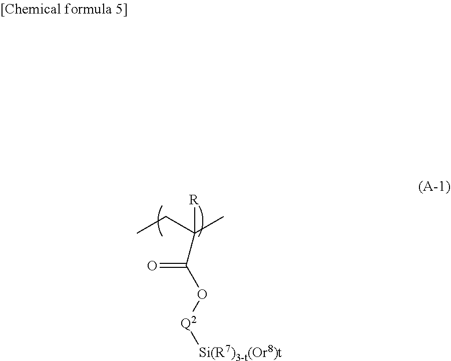
wherein R represents a hydrogen atom or a methyl group, Q² represents a divalent organic group, R⁷ represents an alkyl group of 1 to 18 carbon atoms, R⁸ represents a hydrogen atom or an alkyl group of 1 to 18 carbon atoms, t represents an integer of 1 to 3, and when a plurality of R⁷ or R⁸ groups exist, the plurality of R⁷ or R⁸ may be the same or different.

8. The copolymer according to claim 1, further having a unit (D) having a polyoxyethylene chain that constitutes a main chain.

9. The copolymer according to claim 8, wherein the unit (D) is represented by formula (D1) or (D2) shown below: 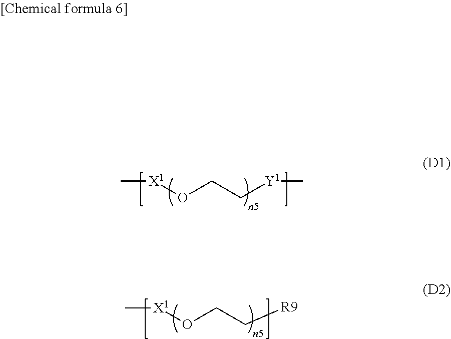
wherein n5 represents an integer of 10 to 200, X¹ and Y¹ each independently represent a divalent group represented by formula (3) or (4) shown below, and R⁹ represents a hydroxyl group, methoxy group or ethoxy group, 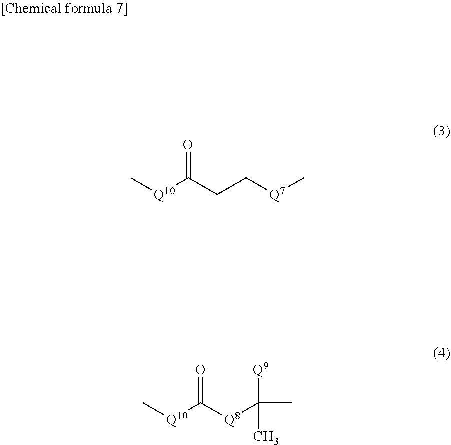
wherein Q⁷ represents a divalent organic group, Q⁸ represents a single bond or an alkylene group of 1 to 5 carbon atoms, Q⁹ represents a cyano group or a methyl group, Q¹⁰ represents a single bond when the divalent group represented by formula (3) or (4) is X¹, and represents an oxygen atom when the divalent group represented by formula (3) or (4) is Y¹, and
when the divalent group represented by formula (3) or (4) is X¹, a Q¹⁰-side terminal is bonded to an oxygen atom adjacent to X¹, whereas when the divalent group represented by formula (3) or (4) is Y¹, a Q¹⁰-side terminal is bonded to a carbon atom adjacent to Y¹.

10. The copolymer according to claim 9, wherein the unit (D) is a unit represented by the formula (D1), and X¹ and Y¹ in the formula (D1) each independently represent a divalent group represented by the formula (3).

11. The copolymer according to claim 2, wherein n2 in the formula (1) is 0.

12. The copolymer according to claim 2, wherein in formula (2), either n3 is 3, n4 is 0 and R⁶ represents a methyl group, or n3 is 2, n4 is an integer of 0 to 7, and R⁶ represents a methyl group or an ethyl group.

13. The copolymer according to claim 2, wherein the unit (B) is represented by formula (B-1) shown below: 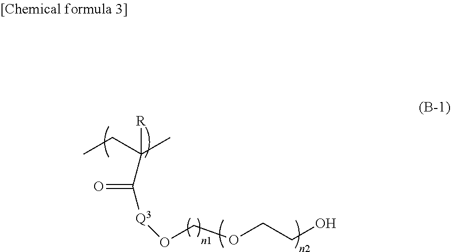
wherein R represents a hydrogen atom or a methyl group, Q³ represents a single bond or a divalent organic group, and n1 and n2 are the same as n1 and n2 respectively in the formula (1).

14. The copolymer according to claim 2, wherein the unit (C) is represented by formula (C-1) shown below: 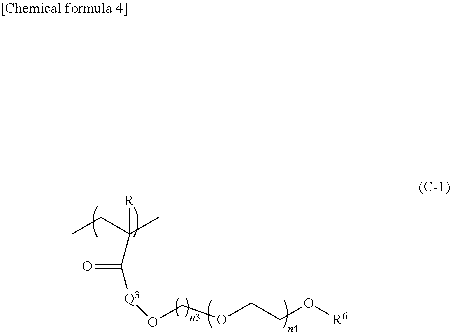
wherein R represents a hydrogen atom or a methyl group, Q³ represents a single bond or a divalent organic group, and R⁶, n3 and n4 are the same as R⁶, n3 and n4 respectively in the formula (2).

15. The copolymer according to claim 2, wherein the unit (A) is represented by formula (A-1) shown below: 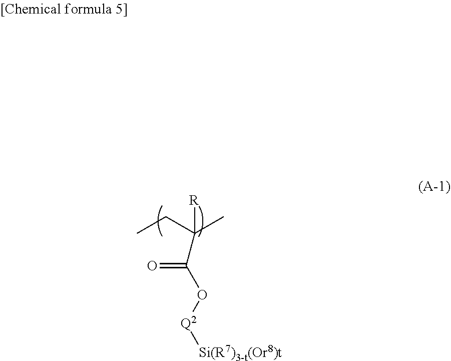
wherein R represents a hydrogen atom or a methyl group, Q² represents a divalent organic group, R⁷ represents an alkyl group of 1 to 18 carbon atoms, R⁸ represents a hydrogen atom or an alkyl group of 1 to 18 carbon atoms, t represents an integer of 1 to 3, and when a plurality of R⁷ or R⁸ groups exist, the plurality of R⁷ or R⁸ may be the same or different.

16. The copolymer according to claim 2, further having a unit (D) having a polyoxyethylene chain that constitutes a main chain.

17. A composition comprising the copolymer according to claim 1.

18. The composition according to claim 17, further comprising a liquid medium.

19. An article having a substrate and a surface layer provided on the substrate, wherein the surface layer is formed from a cured product of the composition according to claim 17.

20. The article according to claim 19, wherein the article is a medical device.
